(19) United States
(12) Patent Application Publication
(10) Pub. No.: US 2015/0199464 A1
(43) Pub. Date: Jul. 16, 2015

(54) FLOORPLAN ANNEAL USING PERTURBATION OF SELECTED AUTOMATED MACRO PLACEMENT RESULTS

(71) Applicant: NVIDIA CORPORATION, Santa Clara, CA (US)

(72) Inventors: Patrick Alan SPROULE, Morgan Hill, CA (US); Shrivathsa BHARGAVRAVICHANDRAN, San Jose, CA (US); Karthik SUNDARAM, San Jose, CA (US); Kevin SAVIDGE, Austin, TX (US)

(73) Assignee: NVIDIA CORPORATION, Santa Clara, CA (US)

(21) Appl. No.: 14/152,601

(22) Filed: Jan. 10, 2014

(51) Int. Cl. G06F 17/50

(52) U.S. Cl. CPC G06F 17/5072

(57) ABSTRACT

A method of designing a floorplan for an integrated circuit comprises executing one or more automated placement processes on one or more seed floorplans to generate at least one output floorplan for each of the one or more seed floorplans, wherein the one or more automated placement processes are included in a plurality of pre-selected automated placement processes. The method further comprises computing a quality score for each output floorplan and, based on the quality scores, selecting at least one of the output floorplans for further execution via at least one automated placement process included in the plurality of pre-selected automated placement processes.

### BACKGROUND OF THE INVENTION

1. Field of the Invention

Embodiments of the present invention relate generally to integrated circuit chip design and, more specifically, to floorplan anneal using perturbation of selected automated macro placement results.

2. Description of the Related Art

An important stage in the design of integrated circuit (IC) chips is the layout, or floorplanning, process, which is typically a combination of automated and manual techniques. An automated macro placer (AMP), usually part of a place and route tool, analyzes a netlist of the various elements of the IC in conjunction with a floorplan bounding box that represents the IC die. Elements in the netlist may include standard cells, such as buffers, inverters, AND/NAND/OR gates, and the like, as well as larger macros, such as blocks of memory and other IC components that can include hundred or more of standard cells. The AMP attempts to place these elements in an optimal configuration based on wire length and connectivity to the respective logic hierarchies associated with each macro. An AMP generally performs an iterative process that continues until the AMP has converged to a locally optimal floorplan solution. For example, convergence may be assumed when a floorplan solution generated by the AMP meets a predetermined resolution criteria, such as when a weighted composite value of multiple qualification metrics falls below a target threshold. The resulting floorplan can then be used as a starting point for the place and route process for the IC chip.

Because the resulting floorplan depends heavily on the initial, or “seed,” floorplan provided to the AMP, and the true quality of the resulting floorplan cannot be accurately judged until it has been proceed through Place & Route, confidence level in the resulting floorplan is typically not high. Consequently, multiple AMP runs (“recipes”), in some cases using multiple seed floorplans, are often performed for a particular netlist and floorplan bounding box in order to generate a plurality of floorplans results. One of the floorplan results is selected for use in the placement and routing process and timing optimization, often via a manual selection process, at which point the timing signature and feasibility of the IC can be quantified. These later steps are time-consuming and involve the use of expensive software tools. Thus, to avoid the necessity of repeated placement and routing runs, the selection of a suboptimal floorplan for placement and routing is highly undesirable.

Accordingly, there is a need in the art for more effective approach to designing integrated circuits.

### SUMMARY OF THE INVENTION

One embodiment of the present invention sets forth a method of designing a floorplan for an integrated circuit. The method comprises executing one or more automated placement processes on one or more seed floorplans to generate at least one output floorplan for each of the one or more seed floorplans, wherein the one or more automated placement processes are included in a plurality of pre-selected automated placement processes. The method further comprises computing a quality score for each output floorplan and, based on the quality scores, selecting at least one of the output floorplans for further execution via at least one automated placement process included in the plurality of pre-selected automated placement processes.

One advantage of the above-described embodiment is that a floorplan thusly selected for place and route has a high likelihood of yielding a suitable IC configuration after the place and route process. Furthermore, the IC configuration may be determined more quickly during place and routing and have improved performance, such as using less power, than an IC configuration based on a conventionally generated floorplan.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram illustrating a conventional design process for an integrated circuit (IC).

FIG. 2 is a block diagram illustrating a computer system configured to implement one or more aspects of the present invention.

FIG. 3 sets forth a block diagram of a floorplanning system, according to one embodiment of the present invention.

FIG. 4 sets forth a flowchart of method steps for designing a floorplan for an integrated circuit, according to one embodiment of the present invention.

FIG. 5 illustrates an example results history generated via the method steps of FIG. 4, according to an embodiment of the present invention.

For clarity, identical reference numbers have been used, where applicable, to designate identical elements that are common between figures. It is contemplated that features of one embodiment may be incorporated in other embodiments without further recitation.

### DETAILED DESCRIPTION

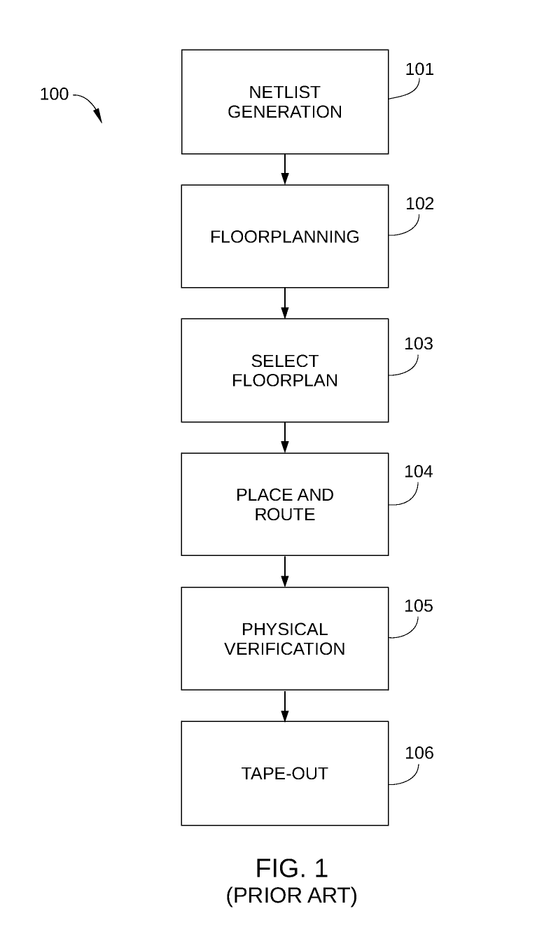

FIG. 1 is a flow diagram illustrating a conventional design process 100 for an integrated circuit (IC). Design process 100 may be used to design the physical implementation of any technically feasible IC, including a central processing unit (CPU), a graphics processing unit (GPU), an application processor or other logic device, a memory chip, a global positioning system (GPS) chip, a radio frequency (RF) transceiver chip, a Wi-Fi chip, a system-on-chip, or any other semiconductor chip. Because physical design process 100 is an overview, only the high-level steps 101-105 are described. Additional steps and sub-steps are excluded in the description of physical design process 100 for simplicity.

In step 101, a netlist is synthesized from a behavior description of the IC to be designed. The netlist is a library of elements for generating the circuit descriptions of the IC to be designed, and thus includes the mix of components that instantiate the logical functions and logical paths making up the IC. Components in the netlist are generally standard cells and macros. Standard cells, such as buffers, inverters, adders, multipliers, logic gates and the like, are for implementing low-level logical functions, while macros are elements of the IC that include a plurality of standard cells, such as blocks of random access memory (RAM) and other subsets or hierarchies of IC components.

In step 102, floorplanning is performed based on the netlist, a floorplan bounding box that defines the geometry of the IC, and in some cases the locations of input/output pins. Floorplanning is the process of identifying structures, such as macros, that should be placed close together, and allocating space for them in such a manner as to meet the sometimes conflicting goals of available space (directly proportional to the cost of the chip), required performance, and the desire to have everything close to everything else. Floorplanning takes into account the macros, memory, and other structures and hierarchies used in the design, the placement needs of all of these elements, and the routing requirements therebetween. An optimized floorplan is highly desirable for a particular IC design since a suboptimal floorplan results in wasted or poorly utilized die area and/or routing congestion. A historically manual process, the increasingly complex nature of floorplanning in modern IC designs caused by the large number of conflicting constraints involved in optimizing a floorplan has led to an automated process referred to as “automated macro placement” being generally used to determine a global optimum floorplan, which is a floorplan that indicates the placement of macros.

In automated macro placement, a global optimum floorplan is generated using an automated macro placer (AMP), which is a software tool that attempts to place the macro elements of the netlist in an optimal configuration. Typically, floorplans generated using an AMP are optimized based on a number of standard qualification metrics, including worst negative slack, wire length, total negative slack, failing endpoints, and total congestion. In other words, an AMP performs an iterative process of incrementally modifying the positions of macros in a floorplan so that one or more predetermined qualification metrics are decreased. The process usually continues until a solution for the floorplan has converged to an optimal solution using a quantifiable quality score calculated for each floorplan generated. For example, convergence may be assumed when a floorplan solution generated by the AMP meets a predetermined resolution criteria, such as when a weighted composite value of the one or more predetermined qualification metrics falls below a target threshold. In this way a global optimum floorplan for the IC being designed is determined for use as a starting point in a subsequent place and route process.

Because the final layout and quality score of a global optimum floorplan determined by an AMP is strongly dependent on the starting seed floorplan, convergence of a solution by an AMP does not necessarily indicate that an adequately optimized solution has been determined. Consequently, in step 102, multiple global optimum floorplans are typically generated using different AMP recipes and/or using differently weighted qualification metrics.

In step 103, a global optimum floorplan is selected for use in the place and route process. This selection process is a manual process in which the various global optimum floorplans generated in step 102 are reviewed in terms of one or more qualification metrics and/or a composite weighted quality score.

In step 104, the place and route process is performed using the global optimum floorplan selected in step 102 as the initial condition. Place and route is a generally computer-implemented process that generates a layout design for the IC, so that all logical paths and functions of the IC being designed are instantiated and interconnected using the global optimum floorplan as an initial condition. Because the thousands or millions of cells making up an IC are placed and interconnected in this step, the place and route process is a concurrent optimization problem that includes an extremely large number of constraints. Consequently, when the starting point for the place and route process is closer to an ideal implementation of the elements in the netlist, a suitable solution can be arrived at more quickly, and the solution so determined may have better overall performance. Conversely, use of a poorly optimized floorplan as an initial condition for place and route can both limit the maximum performance of the IC and increase the time required to complete the place and route process.

In step 105, physical verification of the layout design generated by place and route is performed, generally by one or more automated processes and/or computer-implemented algorithms. Physical verification may include verification that the layout: complies with all photolithographic technology requirements via design rule checking; is consistent with the original netlist and includes all elements included therein; has no antenna effects; and complies with all electrical requirements. In addition, timing optimization of the layout design may be performed, in which interconnect delay and other timing issues are calculated for the various elements of the IC as they are positioned in the design layout. During this process some elements of the netlist may be repositioned to address timing issues that are detected. In this way, an accurate timing signature of the IC can be used to determine feasibility of the design layer before moving forward in physical design process 100.

In step 106, tape-out is performed on the layout design generated by place and route. In electronics design, tape-out is the process by which the design or pattern for the photomask of a circuit is sent for manufacture. Thus, in tape-out, the photomask for the design layout is created.

The later steps of physical design process 100 are the most complex, time-consuming, and expensive, so avoiding repeated iterations of these steps is highly desirable. However, because the final layout and quality score of a global optimum floorplan determined by an AMP is strongly dependent on the starting seed floorplan, and because using more than a limited number of seed floorplans is generally impractical, the confidence that any global optimum floorplan generated by an AMP will yield a feasible layout after place and place is low to medium, and multiple attempts at generating a global optimum floorplan with an AMP may be needed. Worse, inadequacies in the quality of the global optimum floorplan may not be known until after place and route and physical verification have occurred.

According to embodiments of the invention, as described in greater detail below, a technique for automated macro placement generates a floorplan for the place and route process that has a higher probability of producing a suitable IC configuration after the place and route process than prior art automated macro placement techniques.

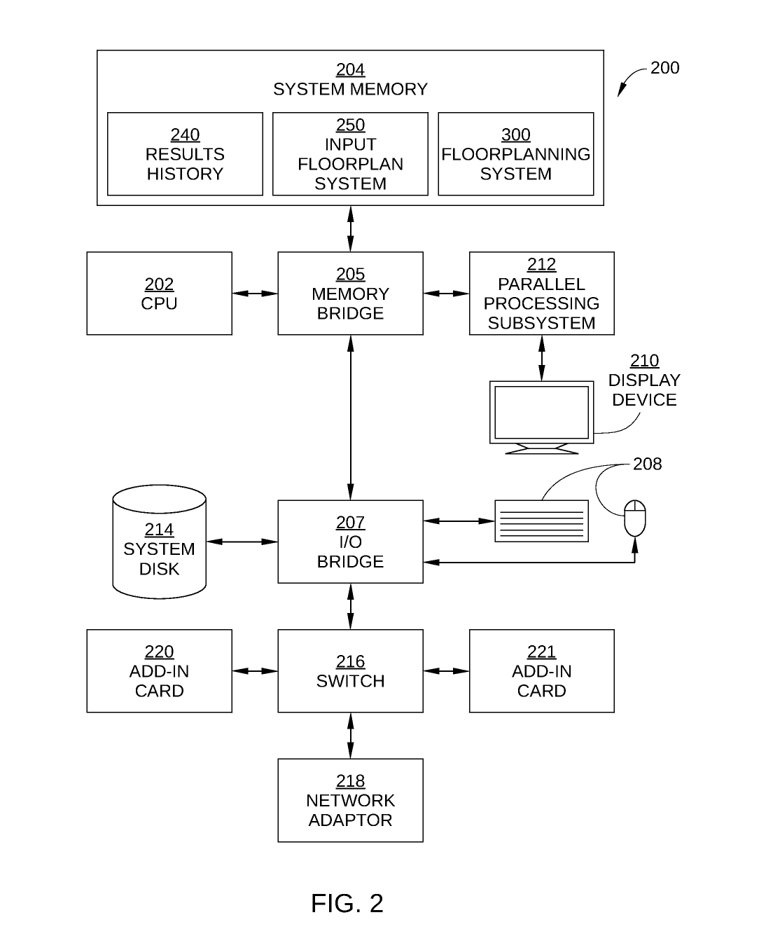

FIG. 2 is a block diagram illustrating a computer system 200 configured to implement one or more aspects of the present invention. As shown, computer system 200 includes, without limitation, a central processing unit (CPU) 202 and a system memory 204 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In operation, I/O bridge 207 is configured to receive user input information from input devices 208, such as a keyboard or a mouse, and forward the input information to CPU 202 for processing via communication path 206 and memory bridge 205. Switch 216 is configured to provide connections between I/O bridge 207 and other components of the computer system 200, such as a network adapter 218 and various add-in cards 220 and 221.

As also shown, I/O bridge 207 is coupled to a system disk 214 that may be configured to store content and applications and data for use by CPU 202 and parallel processing subsystem 212. As a general matter, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbrige chip. In addition, communication paths 206 and 213, as well as other communication paths within computer system 200, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to a display device 210 that may be any conventional cathode ray tube, liquid crystal display, light-emitting diode display, or the like. In such embodiments, the parallel processing subsystem 212 incorporates circuitry optimized for graphics and video processing, including, for example, video output circuitry. Such circuitry may be incorporated across one or more parallel processing units (PPUs) included within parallel processing subsystem 212. In other embodiments, the parallel processing subsystem 212 incorporates circuitry optimized for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and compute processing operations. In various embodiments, parallel processing subsystem 212 may be integrated with one or more of the other elements of FIG. 2 to form a single system. For example, parallel processing subsystem 212 may be integrated with CPU 202 and other connection circuitry on a single chip to form a system on chip (SoC).

System memory 204 includes at least one device driver 203 configured to manage the processing operations of the one or more PPUs within parallel processing subsystem 212. In addition, system memory 204 includes a floorplanning system 300, a results history 240, and an input floorplan history 250. Floorplanning system 300 may be embodied as a set of program instructions loaded in system memory 204 that may be executed by CPU 202. Floorplanning system 300, results history 240, and input floorplan history 250 are described in greater detail below.

It will be appreciated that the system shown herein is illustrative and that variations and modifications are possible. The connection topology, including the number and arrangement of bridges, the number of CPUs 202, and the number of parallel processing subsystems 212, may be modified as desired. For example, in some embodiments, system memory 204 is connected to CPU 202 directly rather than through memory bridge 205, and other devices communicate with system memory 204 via memory bridge 205 and CPU 202. In other alternative topologies, parallel processing subsystem 212 may be connected to I/O bridge 207 or directly to CPU 202, rather than to memory bridge 205. In still other embodiments, I/O bridge 207 and memory bridge 205 may be integrated into a single chip instead of existing as one or more discrete devices. Lastly, in certain embodiments, one or more components shown in FIG. 2 may not be present. For example, switch 216 may be eliminated, and network adapter 218 and add-in cards 220, 221 connect directly to I/O bridge 207.

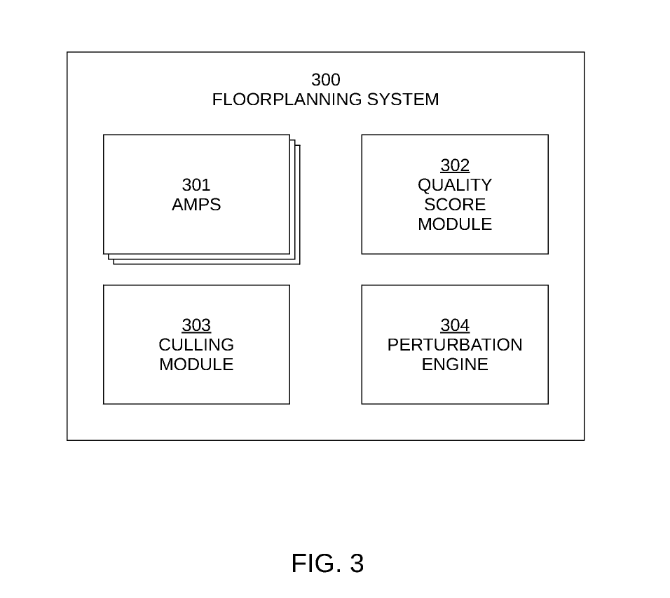

FIG. 3 sets forth a block diagram of floorplanning system 300, according to one embodiment of the present invention. Floorplanning system 300 may be embodied as a set of program instructions that, when executed by CPU 202, cause the processor to perform one or more embodiments of the present invention. As shown, floorplanning system 300 includes one or more AMPs 301, a quality score module 302, a culling module 303, and a perturbation engine 304. AMPs 301 may be any technically feasible macro placement software tools configured for generating output floorplans based on the netlist of the various elements of an IC, a floorplan bounding box that represents the IC die, and/or the locations of input/output pins on the IC die. Quality score module 302 is a software module configured to compute a quality score for output floorplans generated by AMPs 301. Culling module 303 is a software module configured to select one or more output floorplans based on the quality score of each floorplan. Perturbation engine 304 is a software module configured to modify the selected output floorplans for further execution via at least one of AMPs 301.

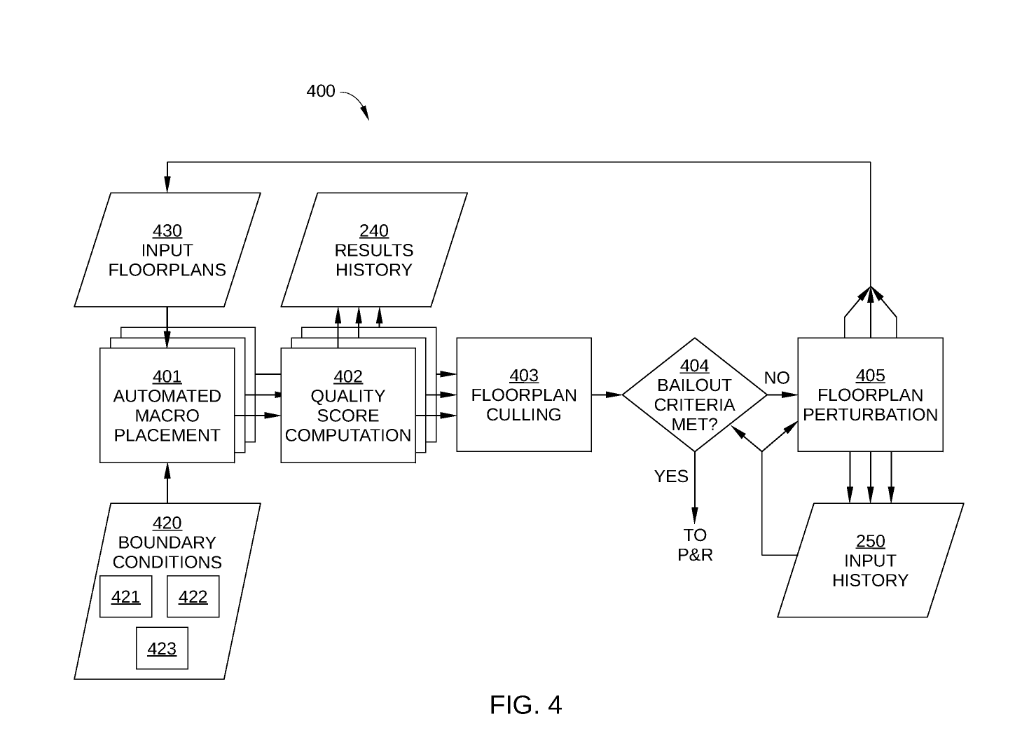

FIG. 4 sets forth a flowchart of method steps for designing a floorplan for an integrated circuit, according to one embodiment of the present invention. Persons skilled in the art will understand that any system configured to perform the method steps, in any order, falls within the scope of the invention. Prior to a method 400 set forth in FIG. 4, boundary conditions 420 for method 400 are determined. Boundary conditions 420 may include a netlist 421 for an IC being designed, a floorplan bounding box 422 that defines the geometry of the IC, and locations 423 of input/output pins for the IC. In addition, prior to method 400, seed floorplans may be generated for use as the input floorplans 430 in the initial run of method 400. In some embodiments, one or more of the seed floorplans used in the initial run of method 400 may be generated by randomly positioning some or all of the macros included in the netlist for the IC. In some embodiments, one or more of the seed floorplans may be based on a floorplan that has been previously used to generate an IC layout design. For example, one or more seed floorplans used in the initial run of method 400 may be based on a previously used floorplan (for a different IC) that implemented a netlist substantially similar to netlist 421. Alternatively or additionally, one or more seed floorplans may be based on a previously used floorplan that has demonstrated a desired performance, such as exceeding a specific threshold value for one or more floorplan qualification metrics (e.g., worst negative slack, wire length, total negative slack, failing endpoints, and total congestion).

As shown, method 400 begins at step 401, where automated macro placement is performed on the one or more input floorplans 430 in conjunction with boundary conditions 420. In some embodiments, an AMP performing step 401 may be a sub-component of a place and route software tool, such as Magma Talus or Synopsys IC-Compiler. As described above in conjunction with FIG. 1, automated macro placement is an iterative process that continues until a solution for the floorplan has converged to an optimal solution. In some embodiments, convergence may be assumed when a floorplan solution generated by the AMP meets a predetermined resolution criteria, such as when a weighted composite value of multiple qualification metrics falls below a target threshold.

In some embodiments, in step 401 multiple AMP “runs” are performed for each seed floorplan 430, where each run is a different automated placement process. Thus, given m seed floorplans 430 and n AMP runs, a total of m x n output floorplan solutions are generated in step 401. In some embodiments, each AMP run may be executed by the same AMP software tool, but each AMP run corresponds to a different weighting of the qualification metrics or other recipe settings used by the AMP software tool. In other embodiments, each AMP run may be executed by different AMP software tools. In the embodiment illustrated in FIG. 4, the number of AMP runs n=3 and three AMP runs are shown being performed on each of seed floorplans 430. However, in other embodiments, more or fewer AMP runs may be executed without exceeding the scope of the invention.

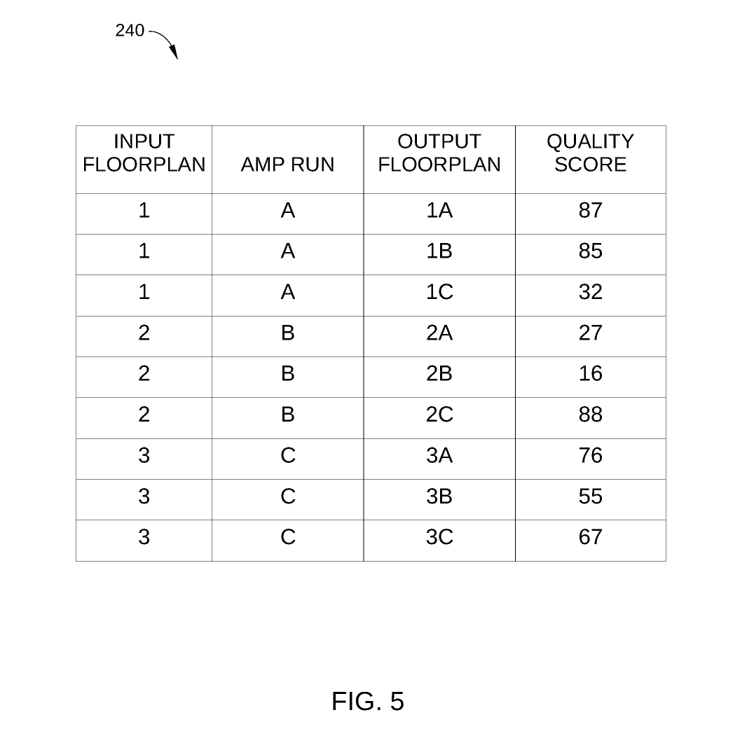

In step 402, a quality score for each output floorplan generated in step 401 is computed. In this way, each floorplan generated in step 401 is quantized as a single data point. In some embodiments, the quality score for each output floorplan is based at least in part on one or more qualification metrics that quantify one or more electrical, physical (e.g., photolithographic manufacturability), or mechanical (e.g., yield-enhancing) attributes of each output floorplan. For example in some embodiments, the qualification metrics on which each quality score is based includes one or more of the qualification metrics worst negative slack, wire length, total negative slack, failing endpoints, and total congestion. Additionally or alternatively, the quality score may be based at least in part on one or more other suitable qualification metrics. In some embodiments, the quality score may include a weighted composite of one or more of the above-described qualification metrics. In some embodiments, the quality scores computed in step 402 are stored in results history 240, which can subsequently be consulted during the perturbation of selected floorplans in step 405. One such embodiment is illustrated in FIG. 5.

FIG. 5 illustrates an example results history 240 generated via the method steps of FIG. 4, according to an embodiment of the present invention. Results history 240 may be configured as a table or other data structure, and may include each input floorplan 430 that undergoes annealing in step 401 (e.g., input floorplans 1-3), each AMP run executed in step 401 (e.g., AMP runs A-C), the output floorplan for each AMP run performed in step 401, and the quality score computed for each of these output floorplans. Storage of this information for each run of method 400 allows the tracking of quality scores from one run to the next as method 400 progresses, thereby providing qualitative insight into the rate of improvement in the quality of output floorplans as method 400 iterates through multiple runs.

Referring back now to FIG. 4, in step 403, a number of the m x n output floorplans from step 401 are selected via a culling process for further execution via the one or more AMP runs used for floorplan annealing in step 401. In some embodiments, the number of output floorplans selected in step 403 is equal to the number m of seed floorplans 430 processed in step 401. Thus, in such embodiments, m output floorplans are selected for further execution. In other embodiments, more or fewer than m floorplans may be selected in step 403. Various selection methods that may be used in step 403 are now described.

In some embodiments, the output floorplans selected in step 403 are chosen based on the quality scores computed in step 402. For example, in some embodiments, the m floorplans with the best quality scores are selected. In some embodiments one or more of the floorplans selected in step 403 may be a combination of two or more floorplans with the best quality scores. For example, in some embodiments, in step 403 an algorithm determines the average location of each placeable macro element included in the output floorplans or in a subset of output floorplans having higher quality scores. In such embodiments, an output floorplan is synthesized from these average locations of placeable macro elements and is included in the output floorplans selected in step 403. The location average for each macro may be weighted by multiple factors, including size of the macro, number of pins associated with the macro, and average/min/max wire length of all connected nets associated with the macro. In yet other embodiments, a floorplan that is computed to be closest to such a weighted average floorplan is one of the floorplans selected in step 403. Other combinations of some or all of the output floorplans generated in step 401 may also be used to synthesize a floorplan that is then selected in step 403.

In some embodiments, one of the output floorplans selected in step 403 may have a low quality score or even the worst score of the output floorplans generated in step 401. On the assumption that the output floorplans with the best quality scores may be substantially co-located in the solution space that includes all possible floorplan configurations, such embodiments facilitate the exploration of different regions of the solution space. Theoretically, these different regions of the solution space may contain one or more paths to more optimal floorplan configurations that are shorter, and involve fewer runs of method 400, than the regions of solution space in which the higher quality scoring output floorplans are located.

In step 404, bailout criteria are checked and, when met, method 400 ends and one or more of the floorplans selected in step 403 are advanced to the place and route process. When the bailout criteria are not met, method 400 proceeds to step 405. In some embodiments, multiple bailout criteria may be considered in step 404. One criterion for bailout may be when the computed value of one or more qualification metrics (worst negative slack, wire length, total negative slack, failing endpoints, total congestion, etc.) for any of the floorplans selected in step 403 falls below a predetermined threshold value. Alternatively, a criterion for bailout may be when the computed value of all of a predetermined group of qualification metrics for a particular floorplan selected in step 403 falls below a respective predetermined threshold value. Yet another criterion may be when a run-to-run rate of change across one or more consecutive runs (trending) of one or more qualification metrics or quality scores in method 400 falls below a predetermined threshold value. In some embodiments, such a predetermined threshold may be a dynamically varying value that is a function of some factor, such as the number of runs completed in method 400, the absolute value of quality scores or qualification metrics, etc.

In some embodiments, additional criteria may include a relative change of one or more measured qualification metrics compared to the same one or more qualification metrics of a predecessor floorplan. In the context of method 400, a first floorplan is considered a “predecessor” floorplan of a second floorplan when the second floorplan is an output floorplan generated by performing step 401 on a perturbed version of the first floorplan. Thus, if a relative change (e.g., percentage change) in a one or more qualification metrics of interest between the first floorplan and the second floorplan is less than a predetermined threshold value, the bailout criterion is considered satisfied. Such bailout criteria allow method 400 to end when improvements between runs of method 400 prove to be ever-decreasing in quantity, indicating that further runs of method 400 will provide diminishing returns in quality score improvement. It is noted that information from input floorplan history 250 may be used to determine the relative changes in one or more qualification metrics between a floorplan and a predecessor floorplan. Furthermore, in some embodiments, the relative change criterion may not be a fixed value, but instead changes dynamically as a function of the number of runs performed in method 400 or as a function of other factors.

In step 405, the output floorplans selected in step 403 are perturbed via a perturbation engine. For example, in some embodiments, some or all of the macros in an output floorplan that is perturbed in step 405 are randomly relocated a predetermined distance. In some embodiments, an output floorplan is perturbed by combining (e.g., averaging) two or more floorplans. For example, an output floorplan selected in step 403 may be combined with one or more of the other floorplans selected in step 403. In another example, an output floorplan is perturbed by being combined with some or all of a predecessor floorplan, i.e., a floorplan that was previously perturbed and then used as the input floorplan 430 that generated the output floorplan now being perturbed. In yet another example, an output floorplan is perturbed by being combined with some or all of a predecessor floorplan of a predecessor floorplan. In another example, an output floor plan is perturbed by being replaced with a predecessor floorplan, then being perturbed differently than the predecessor floorplan was perturbed. It is noted that information from input floorplan history 250 may be used to implement perturbation of an output floorplan when using predecessor floorplans in this way. In some embodiments, the perturbed output floorplans generated in step 405 may include macro element positions that are not fully legalized (i.e., the macro elements may overlap). In some embodiments, locations of some or all of the macros in an output floorplan that is perturbed in step 405 are perturbed a distance based at least in part on a quality score associated with the output floorplan and a quality score associated with at least one predecessor floorplan.

For example, in one such embodiment, the distance that some or all of the macros are perturbed is inversely proportional to a difference between the quality score of the output floorplan and the quality score of one or more predecessor floorplans. In this way, as a global optimum is approached, perturbation of macro locations in a seed floorplan is perturbed less and less.

The perturbation in step 405 is intended to modify the selected output floorplans sufficiently prior to undergoing subsequent floorplan annealing so that the output floorplans occupy a substantially different location in solution space than they did prior to perturbation. In this way, an output floorplan that is in a local minimum in solution space may be relocated outside of the local minimum, thereby facilitating the exploration of different regions of the solution space in later runs of method 400.

Upon completion of the perturbation of the output floorplans, the perturbed output floorplans are then stored in input floorplan history 250 for use in steps 404 and 405. The perturbed output floorplans are then defined as input floorplans 430, and method 400 begins another run. In some embodiments, input floorplan history 250 is a table or other data mapping structure that maps perturbed output floorplans to predecessor floorplans. In some embodiments, input floorplan history 250 may be combined with results history 240, so that input floorplans, results (i.e., quality score and selected output floorplans), and resulting perturbed output floorplans are mapped to each other in a single data structure.

In sum, embodiments of the invention set forth systems and methods of automated macro placement in which a floorplan is generated for the place and route process. According to some embodiments, multiple output floorplans are generated using automated macro placement and a quality score is computed for each. A subset of the output floorplans is then selected based on the quality score, each output floorplan in the subset is perturbed, and the automated macro placement process is performed on the perturbed output floorplans to generate output floorplans with improved quality scores.

An advantage of the above-described embodiments is that output floorplans generated as described herein generally have a high likelihood of yielding a suitable IC configuration after the place and route process. In addition, because the selection process for output floorplans is an automated process, an advantageously large number of output floorplans can be evaluated. This allows the use of a larger number of AMP runs and input floorplans, thereby increasing confidence that an diverse sampling of solution space has been sampled and an output floorplan selected for place and route is a sufficiently optimized floorplan. Consequently, an IC configuration may be determined more quickly during place and route and have improved performance, such as using less power, than an IC configuration based on a conventionally generated floorplan.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

While the foregoing is directed to embodiments of the present invention, other and further embodiments of the invention may be devised without departing from the basic scope thereof, and the scope thereof is determined by the claims that follow.

1. A method of designing a floorplan for an integrated circuit, the method comprising:
executing one or more automated placement processes via a processor on one or more seed floorplans to generate at least one output floorplan for each of the one or more seed floorplans by performing an iterative process that continues until a predetermined resolution criterion is met, wherein the one or more automated placement processes are included in a plurality of preselected automated placement processes;
computing a quality score for each output floorplan; and
based on the quality scores, selecting one of the at least one output floorplans for further execution via at least one automated placement process included in the plurality of preselected automated placement processes.

2. The method of claim 1, further comprising, for each of the output floorplans selected for further execution:
perturbing locations of one or more elements in the output floorplan to generate a perturbed output floorplan; and
executing an automated placement process included in the plurality of preselected automated placement processes on the perturbed output floorplan by performing an iterative process that continues until a predetermined resolution criterion is met.

3. The method of claim 2, wherein executing the automated placement process on the perturbed output floorplan comprises executing one of the automated placement processes included in the one or more automated placement processes executed on the one or more seed floor plans.

4. The method of claim 2, wherein perturbing locations of the one or more elements in the output floorplan comprises combining the output floorplan with at least one predecessor floorplan.

5. The method of claim 1, wherein selecting one of the at least one output floorplans comprises selecting a number of output floor plans equal to the number of seed plans included in the one or more seed floorplans

6. A non-transitory computer readable medium storing instructions that, when executed by a processor, cause the processor to perform the steps of:
executing one or more automated placement processes on one or more seed floorplans to generate at least one output floorplan for each of the one or more seed floorplans by performing an iterative process that continues until a predetermined resolution criterion is met, wherein the one or more automated placement processes are included in a plurality of preselected automated placement processes;
computing a quality score for each output floorplan; and
based on the quality scores, selecting one of the at least one output floorplans for further execution via at least one automated placement process included in the plurality of preselected automated placement processes.

7. The non-transitory computer readable medium of claim 6, further comprising instructions that, when executed by the processor, cause the processor to perform, for each of the output floorplans selected for further execution, the steps of:
perturbing locations of one or more elements in the output floorplan to generate a perturbed output floorplan; and
executing an automated placement process included in the plurality of preselected automated placement processes on the perturbed output floorplan performing an iterative process that continues until a predetermined resolution criterion is met.

8. The non-transitory computer readable medium of claim 7, wherein executing the automated placement process on the perturbed output floorplan comprises executing one of the automated placement processes included in the one or more automated placement processes executed on the one or more seed floor plans.

9. The non-transitory computer readable medium of claim 7, wherein perturbing locations of the one or more elements in the output floorplan comprises perturbing each location a distance based at least in part on a quality score associated with the output floorplan and a quality score associated with at least one predecessor floorplan.

10. The non-transitory computer readable medium of claim 9, wherein the distance is inversely proportional to a difference between the quality score of the output floorplan and the quality score of the least one predecessor floorplan.

11. The non-transitory computer readable medium of claim 7, wherein perturbing locations of the one or more elements in the output floorplan comprises combining the output floorplan with at least one predecessor floorplan.

12. The non-transitory computer readable medium of claim 6, wherein the quality score for each output floorplan is based at least in part on one or more qualification metrics that quantify one or more electrical, physical, or mechanical attributes of the output floorplan.

13. The non-transitory computer readable medium of claim 6, wherein the quality score comprises a weighted composite of one or more qualification metrics that quantify one or more electrical, physical, or mechanical attributes of the output floorplan.

14. The non-transitory computer readable medium of claim 13, wherein the one or more qualification metrics include at least one of worst negative slack, wire length, total negative slack, failing endpoints, and total congestion.

15. The non-transitory computer readable medium of claim 6, wherein the quality score for each output floorplan is based at least in part on one of an absolute score of a qualification metric that quantifies an electrical, physical, or mechanical attribute of the output floorplan and a rate of change of the qualification metric.

16. The non-transitory computer readable medium of claim 15, wherein selecting one of the at least one output floorplans comprises selecting a number of output floor plans equal to the number of seed plans included in the one or more seed floorplans

17. The non-transitory computer readable medium of claim 6, wherein at least one of the one or more seed floorplans includes a plurality of macro elements associated with an integrated circuit that are randomly disposed within a bounding box that corresponds to the integrated circuit.

18. The non-transitory computer readable medium of claim 6, further comprising instructions that, when executed by the processor, cause the processor to perform the steps of:
computing a modified floorplan based on at least two of the at least one output floorplans; and
based on the modified floorplan and the quality scores, selecting at least one of the at least one output floorplans for further execution via at least one automated placement process included in the plurality of preselected automated placement processes.

19. The non-transitory computer readable medium of claim 18, wherein computing a modified floorplan comprises computing a weighted-average location of each of the plurality of macro elements associated with an integrated circuit in the at least two of the at least one output floorplans.

20. A computing device comprising:
a memory; and
a processor coupled to the memory and that is configured to:
execute one or more automated placement processes on one or more seed floorplans to generate at least one output floorplan for each of the one or more seed floorplans by performing an iterative process that continues until a predetermined resolution criterion is met, wherein the one or more automated placement processes are included in a plurality of preselected automated placement processes;
compute a quality score for each output floorplan; and
based on the quality scores, select one of the at least one output floorplans for further execution via at least one automated placement process included in the plurality of preselected automated placement processes.
